(19) United States
(12) Patent Application Publication
(10) Pub. No.: US 2011/0119718 A1
(43) Pub. Date: May 19, 2011

(54) CONTENT REPRODUCTION APPARATUS, CONTROLLER, CONTENT REPRODUCTION SYSTEM, COMMUNICATION METHOD, AND REPRODUCTION APPARATUS DETERMINATION METHOD

(76) Inventor: Toshiki YAMAMURA, Osaka (JP)

(21) Appl. No.: 12/948,126

(22) Filed: Nov. 17, 2010

(30) Foreign Application Priority Data
Nov. 18, 2009 (JP) 2009-262681
Oct. 13, 2010 (JP) 2010-231021

(51) Int. Cl. H04N 7/18

(52) U.S. Cl. 725/81; 725/82

(57) ABSTRACT

A content reproduction apparatus, which is capable of reproducing, in accordance with an instruction from a controller, content provided from a content output apparatus via a network, includes: a first communication unit which receives a first search request; a second communication unit which receives a second search request from the controller and has a shorter communication distance that allows communication with the controller than the communication distance of the first communication unit; and a control unit which transmits to the controller, using the first communication unit, a first response including identification information of the content reproduction apparatus when the first communication unit receives the first search request, and which transmits to the controller, using one of the first and second communication units, a second response to specify the identification information included in the first response that has been transmitted, when the second communication unit receives the second search request.

### BACKGROUND OF THE INVENTION

(1) Field of the Invention

The present invention relates to a content reproduction apparatus which can reproduce content provided via a network, and also relates to a controller or the like which controls the content reproduction apparatus.

(2) Description of the Related Arts

A technique of connecting audio-visual (AV) devices in house and sharing content between the AV devices, and a technique of controlling the AV devices using another device have recently become popular. For example, there is a content reproduction system which causes, via a controller, a reproduction apparatus such as a digital television (DTV) equipped with a function called renderer, to reproduce content held by a digital video recorder (DVR).

Such a content reproduction system causes the controller, from which a user operates the system, to display title information and so on of the content held by the DVR. The user selects content to be reproduced, using the controller at hand. The content thus selected is reproduced by the DTV. Such an operation is called “hand operation”.

With reference to FIGS. 11 and 12, a technique of causing, via the controller, the reproduction apparatus to reproduce the content provided by a conventional server will be described.

As shown in FIG. 11, a controller 1002, a reproduction apparatus 1003, and a server 1004 are connected to each other via a cable 1007. FIG. 12 shows a communication sequence in this configuration when reproducing, using the reproduction apparatus 1003, the content provided by the server 1004 via the controller 1002.

First, the controller 1002 transmits a reproduction-apparatus search request for searching for the reproduction apparatus 1003 on the network (S901). When receiving a response from the reproduction apparatus 1003 (S902), the controller 1002 subsequently transmits a detailed-device-information obtainment request for obtaining detailed device information of the reproduction apparatus 1003 that is detected (S903). Next, the controller 1002, having received the detailed information from the reproduction apparatus 1003 (S904), transmits a search-server request for searching for the server 1004 on the network (S905). When receiving a response from the server 1004 (S906), the controller 1002 subsequently transmits a detailed-device-information obtainment request for obtaining detailed information on the detected server 1004 (S907), and receives a response from the server 1004 (S908).

The controller 1002, having detected the reproduction apparatus 1003 and the server 1004 that are present on the network, determines the server 1004 from which content information is to be obtained and the reproduction apparatus 1003 that is to reproduce the content (S909). Next, the controller 1002 transmits, to the server 1004, a content-information obtainment request for obtaining content information (S910). The controller 1002, having received the content information from the server 1004 as a response to the content-information obtainment request (S911), displays the content information, including a title, of a display unit (not shown) of the controller 1002. The user operating the controller 1002 selects, using an operation input unit which is not shown in the figure, the content to be reproduced from the content information displayed in the display unit of the controller 1002 (S912). When the user selects the content to be reproduced, the controller 1002 transmits, to the reproduction apparatus 1003, a content reproduction request indicating a location and an identifier of the content (S913). The reproduction apparatus 1003, having received the content reproduction request, returns a response (S914), and transmits a content obtainment request to the server 1004 at which the content indicated by the content reproduction request is located (S915). The server 1004 transmits the content, as a response, to the reproduction apparatus 1003 (S916). The reproduction apparatus 1003, having received the content from the server 1004, reproduces the content (S917).

In addition, Patent Reference 1 (Japanese Unexamined Patent Application Publication No. 2008-263308) describes a remote-control device which reliably performs pairing of a remote controller and an electric device that are connected by radio waves. This remote-control device includes a light-emitting unit which emits light by infrared rays, transmits a start of paring setting, using infrared rays, and exchanges unique information of the electric device and the remote-control device, using radio waves.

### SUMMARY OF THE INVENTION

According to a technique disclosed in Non-Patent Reference 1 (DLNA Networked Device Interoperability Guidelines expanded: October 2006), it is possible to reproduce content provided by a server detected by a controller, using a reproduction apparatus that is detected. On the other hand, assuming that such a reproduction apparatus is used in house, a plurality of such reproduction apparatuses are provided in a plurality of places such as a living room, a bedroom, and a children's room. In addition, the controller is portable, and is assumed to be freely carried around in house. Furthermore, it is assumed that the reproduction apparatus, the server, and the controller in house are wiredly or wirelessly connected to the network. When using the controller in the living room, it is necessary to use the reproduction apparatus provided in the living room; alternatively, when using the controller in the bedroom, it is necessary to use the reproduction apparatus provided in the bedroom.

However, a conventional technique results in detecting the plurality of reproduction apparatuses connected to the network. This presents a problem that the user, freely carrying around and using the controller, has to select, from among the reproduction apparatuses detected by the controller, the reproduction apparatus provided in the living room when the user is in the living room, and has to select the reproduction apparatus provided in the bedroom when in the bedroom.

In this context, the paring setting as described in Patent Reference 1 results in setting of paring between the remote controller and a particular electronic device, and does not allow the remote controller to operate another electronic device at the same time. In other words, for example, once the controller is paired with the reproduction apparatus in the bedroom, the controller cannot operate the reproduction apparatus in the living room.

The present invention has been conceived in view of the above problem, and it is an object of the present invention to provide a content reproduction apparatus, a controller, a content reproduction system, a communication method, and a reproduction apparatus determination method which allow automatically determining, based on a location of a controller, a content reproduction apparatus that is to reproduce content provided via a network.

To achieve the above object, a content reproduction apparatus according to an aspect of the present invention is a content reproduction apparatus capable of reproducing, in accordance with an instruction from a controller, content provided from a content output apparatus via a network, and the content reproduction apparatus includes: a first communication unit which receives a first search request to search for an apparatus capable of reproducing the content; a second communication unit which receives a second search request from the controller, the second communication unit having a shorter communication distance that allows communication with the controller than a communication distance of the first communication unit, and the second search request being a request to search for the apparatus capable of reproducing the content; and a control unit which transmits to the controller, using the first communication unit, a first response including identification information of the content reproduction apparatus when the first communication unit receives the first search request, and which transmits to the controller, using one of the first and second communication units, a second response to specify the identification information included in the first response that has been transmitted, when the second communication unit receives the second search request.

According to this configuration, when the second communication unit, which has a shorter communication distance that allows communication with the controller than the communication distance of the first communication unit, receives the second search request, it is possible to transmit the second response to specify the identification information included in the first response already transmitted by the first communication unit. Thus, the controller can specify the identification information of the content reproduction apparatus capable of communicating using the second communication unit, that is, the content reproduction apparatus located near the controller. As a result, the controller can automatically determine, based on the location of the controller, the content reproduction apparatus that is to reproduce the content provided via the network, without obtaining detailed location information of the controller and the content reproduction apparatus.

In addition, preferably, the first communication unit further receives, from the controller, an event notice request which requests a transmission of an event notice to the controller when the second communication unit receives the second search request, and the control unit transmits, using the first communication unit, the event notice as the second response, when the second communication unit receives the second search request during a predetermined period of time after the first communication unit receives the event notice request.

According to this configuration, it is possible to transmit, through event notice, the second response that is a response to the second search request.

In addition, preferably, the first communication unit communicates with the controller even when the controller and the content reproduction apparatus are not visible to each other, and the second communication unit communicates with the controller only when the controller and the content reproduction apparatus are visible to each other.

According to this configuration, since the second communication unit can communicate with the controller only when the second communication unit and the controller are visible to each other, the content reproduction apparatus that is located at a position not visually recognizable by the user operating the controller cannot receive the second search request. That is, the controller can specify the identification information of the content reproduction apparatus located at a position visually recognizable by the user operating the controller. Accordingly, the controller can automatically determine, based on the location of the controller, the content reproduction apparatus located at the position visually recognizable by the user operating the controller.

In addition, preferably, the second communication unit unidirectionally communicates from the controller to the content reproduction apparatus, and the control unit transmits the second response to the controller, using the first communication unit. Specifically, the second communication unit preferably communicates with the controller, using an infrared ray.

According to this configuration, it is possible to configure the second communication unit, using an infrared communication function of a number of mobile terminals such as a cellular phone or a remote controller.

In addition, preferably, the second communication unit bidirectionally and wirelessly communicates with the controller, and the control unit transmits the second response to the controller, using the second communication unit. Specifically, the second communication unit preferably communicates with the controller by Bluetooth.

According to this configuration, it is possible to configure the second communication unit, using Bluetooth (trademark), which is used for a number of mobile terminals such as a cellular phone or a remote controller.

In addition, preferably, the identification information included in the first response includes an identifier unique to the first communication unit.

According to this configuration, since the identification information includes the identifier unique to the first communication unit, it is easier to identify the content reproduction apparatus when performing communication using the first communication unit.

In addition, a communication method according to an aspect of the present invention is a communication method performed by a content reproduction apparatus capable of reproducing, in accordance with an instruction from a controller, content provided from a content output apparatus via a network, and the communication method includes: receiving, using a first communication unit, a first search request to search for an apparatus capable of reproducing the content; transmitting, using the first communication unit, a first response after receiving the first search request, the first response including identification information of the content reproduction apparatus; receiving, using a second communication unit, a second search request from the controller, the second communication unit having a shorter communication distance that allows communication with the controller than a communication distance of the first communication unit, and the second request being a request to search for the apparatus capable of reproducing the content; and transmitting, after receiving the second search request, a second response to the controller, using one of the first and second communication units, the second response being for specifying identification information included in the first response transmitted in the transmitting of a first response.

With this, it is possible to produce the same advantageous effect as in the content reproduction apparatus described above.

In addition, a controller according to an aspect of the present invention is a controller which determines a content reproduction apparatus that is to reproduce content provided from a content output apparatus via a network, and the controller includes: a first communication unit which transmits a first search request to search for an apparatus capable of reproducing the content, and which receives a first response to the first search request; a second communication unit which transmits a second search request to a content reproduction apparatus that is identified by the first response, the second communication unit having a shorter communication distance that allows communication with the content reproduction apparatus than a communication distance of the first communication unit, and the second search request being a request to search for the apparatus capable of reproducing the content; and a control unit which determines, as the content reproduction apparatus that is to reproduce the content, the content reproduction apparatus that has transmitted a second response to the second search request, when one of the first and second communication units receives the second response.

According to this configuration, the second communication unit, which has a shorter communication distance that allows communication with the content reproduction apparatus than the communication distance of the first communication unit, transmits the second search request. Then, when the second response to the second search request is received, the content reproduction apparatus from which the second response has been transmitted is determined as the content reproduction apparatus that is to reproduce the content provided via the network. That is, it is possible to determine, as the content reproduction apparatus that is to reproduce the content, the content reproduction apparatus capable of communicating using the second communication unit, that is, the content reproduction apparatus located near the controller. As a result, the controller can automatically determine, based on the location of the controller, the content reproduction apparatus that is to reproduce the content provided via the network, without obtaining detailed location information of the controller and the content reproduction apparatus.

In addition, a reproduction apparatus determination method according to an aspect of the present invention is a reproduction apparatus determination method performed by a controller which determines a reproduction apparatus that is to reproduce content provided from a content output apparatus via a network, and the reproduction apparatus determination method includes: transmitting, using a first communication unit, a first search request to search for an apparatus capable of reproducing the content; receiving a first response to the first search request, using the first communication unit; transmitting, using a second communication unit, a second search request to the content reproduction apparatus identified by the first response, the second communication unit having a shorter communication distance that allows communication with the content reproduction apparatus than a communication distance of the first communication unit, and the second search request being a request to search for the apparatus capable of reproducing the content; and determining, as the content reproduction apparatus that is to reproduce the content, the content reproduction apparatus that has transmitted a second response to the second search request, when the second response is received using one of the first and second communication units.

With this, it is possible to produce the same advantageous effect as with the controller described above.

In addition, a content reproduction system according to an aspect of the present invention is a content reproduction system including: a content output apparatus; a controller; and a content reproduction apparatus capable of reproducing, in accordance with an instruction from the controller, content provided from the content output apparatus via a network, and the controller includes: a first communication unit which transmits a first search request to search for an apparatus capable of reproducing the content, and which receives a first response to the first search request; a second communication unit which transmits a second search request to the content reproduction apparatus identified by the first response, the second communication unit having a shorter communication distance that allows communication with the content reproduction apparatus than a communication distance of the first communication unit, and the second search request being a request to search for the apparatus capable of reproducing the content; and a first control unit which determines, as the content reproduction apparatus that is to reproduce the content, the content reproduction apparatus that has transmitted a second response to the second search request, when one of the first and second communication units receives the second response, and the content reproduction apparatus includes: a third communication unit which receives the first search request; a fourth communication unit which receives the second search request from the controller, the fourth communication unit having a shorter communication distance that allows communication with the controller than a communication distance of the third communication unit; and a second control unit which transmits, using the third communication unit, the first response to the controller when the third communication unit receives the first search request, and which transmits, using one of the third and fourth communication units, the second response to the controller when the fourth communication unit receives the second search request.

According to this configuration, the second communication unit, which has a shorter communication distance that allows communication with the content reproduction apparatus than the communication distance of the first communication unit, transmits the second search request. Then, when the second response to the second search request is received, the content reproduction apparatus from which the second response has been transmitted is determined as the content reproduction apparatus that is to reproduce the content provided via the network. That is, it is possible to determine, as the content reproduction apparatus that is to reproduce the content, the content reproduction apparatus capable of communicating using the second communication unit, that is, the content reproduction apparatus located near the controller. As a result, the controller can automatically determine, based on the location of the controller, the content reproduction apparatus that is to reproduce the content provided via the network, without obtaining detailed location information of the controller and the content reproduction apparatus.

In addition, the present invention can be realized as a program causing a computer to execute each step included in the communication method or the reproduction apparatus determination method. Moreover, it goes without saying that such a program can be distributed via a computer readable non-transitory recording medium such as a compact disc read only memory (CD-ROM), and a transmission medium such as the Internet.

According to the present invention, it is possible to automatically determine, based on the position at which the controller is operated, the content reproduction apparatus that is to reproduce the content provided via the network.

### FURTHER INFORMATION ABOUT TECHNICAL BACKGROUND TO THIS APPLICATION

The disclosure of Japanese Patent Application No. 2009-262681 filed on Nov. 18, 2009 and Japanese Patent Application No. 2010-231021 filed on Oct. 13, 2010 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the Drawings:

FIG. 1 is a diagram showing an example configuration of a content reproduction system according to a first embodiment of the present invention;

FIG. 2 is a block diagram showing a configuration of a controller according to the first embodiment of the present invention;

FIG. 3 is a block diagram showing a configuration of a DTV according to the first embodiment of the present invention;

FIG. 4 is a block diagram showing a configuration of the DVR according to the first embodiment of the present invention;

FIG. 5 is a diagram for describing a communication sequence in the content reproduction system according to the first embodiment of the present invention;

FIG. 6 is a flowchart showing a flow of processing performed by the controller according to the first embodiment of the present invention;

FIG. 7 is a flowchart showing a flow of processing performed by the DTV according to the first embodiment of the present invention;

FIG. 8 is a diagram for describing a communication sequence in a content reproduction system according to a second embodiment of the present invention;

FIG. 9 is a flowchart showing a flow of processing performed by a controller according to the second embodiment of the present invention;

FIG. 10 is a flowchart showing a flow of processing performed by a DTV according to the second embodiment of the present invention;

FIG. 11 is a diagram showing an example configuration of a conventional content reproduction system; and

FIG. 12 is a diagram for describing a communication sequence in the conventional content reproduction system.

### DESCRIPTION OF THE PREFERRED EMBODIMENTS

### First Embodiment

### System Configuration

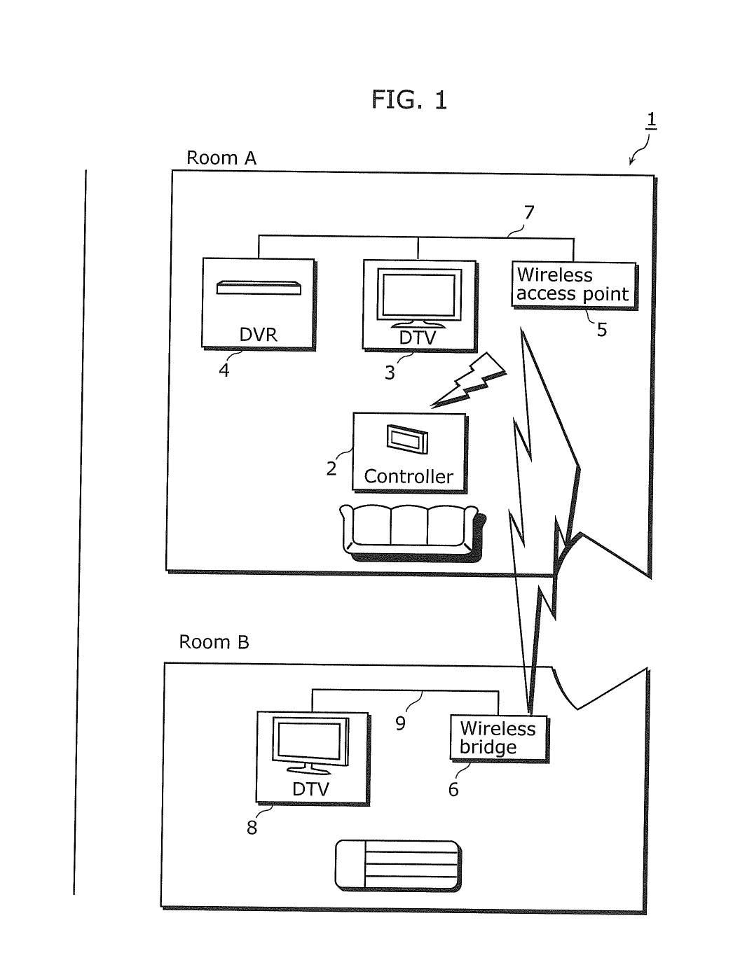

Hereinafter, a first embodiment of the present invention will be described with reference to FIGS. 1 to 7.

FIG. 1 is a diagram showing an example configuration of a content reproduction system according to the first embodiment of the present invention. In FIG. 1, a content reproduction system 1 includes: a plurality of digital televisions (DTV3, DTV8), and a digital video recorder (DVR4), and a controller 2 which are provided in a plurality of rooms in house (room A, room B).

The controller 2, for example, is a mobile terminal including a touch panel, and determines one of the content reproduction apparatuses (DTV3, DTV8) that is to reproduce content provided from DVR4 via a network.

Each of DTV3 and DTV8 corresponds to the content reproduction apparatus and functions as what is called a renderer. Specifically, DTV3 and DTV8 reproduce the content provided from DVR4 via the network, in accordance with an instruction from the controller 2.

DVR4 is an example of a content output apparatus, and functions as what is called a server. Specifically, DVR4 provides the content to DTV3 or DTV8 via the network.

Note that the content is data including at least one of video data and sound data. In the present embodiment, it is not particularly necessary to limit a file format, a compression method or the like for the content.

In room A, DTV3, DVR4, and a wireless access point 5 which has a wireless function and a network-hub function are connected to the network via a cable 7.

The controller 2, which is located in room A, is wirelessly connected to the network via the wireless access point 5.

In room B, DTV8 and a wireless bridge 6 which performs mutual conversion between a wired network and a wireless network are connected to the network via a cable 9.

The controller 2 in room A and the wireless bridge 6 in room B are wirelessly connected to each other via the wireless access point 5 in room A, to be included in the network. Thus, the controller 2, DTV3, and DVR4 in room A and DTV8 in room B are connected to the same network.

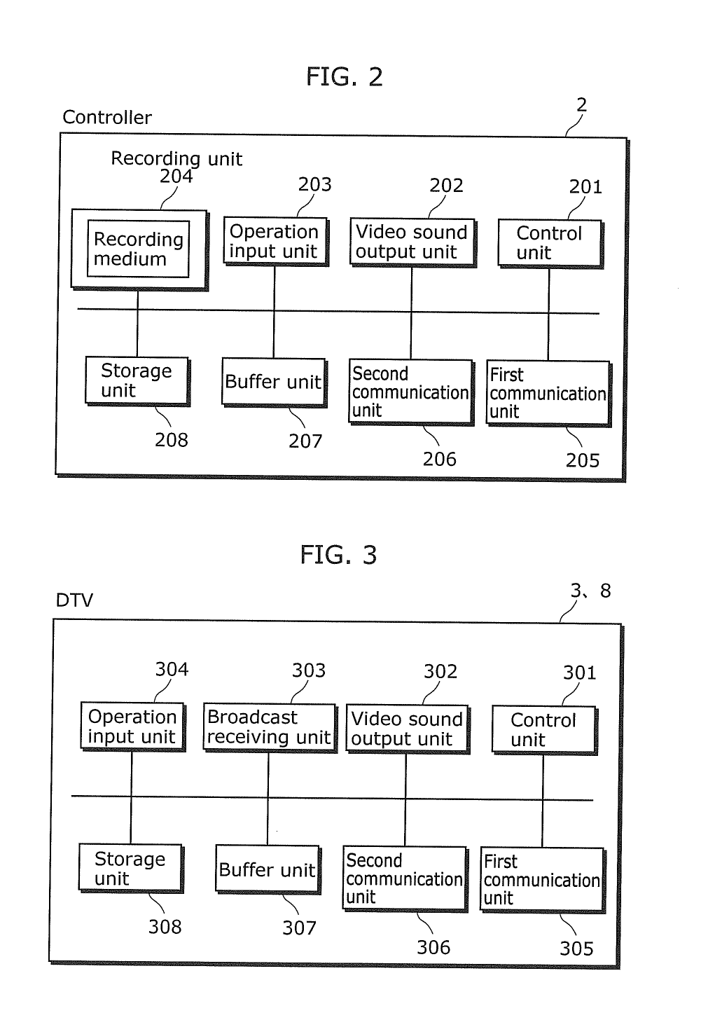

FIG. 2 is a block diagram showing a configuration of the controller 2 according to the first embodiment of the present invention. The controller 2 includes: a control unit 201, a video sound output unit 202, an operation input unit 203, a recording unit 204, a first communication unit 205, a second communication unit 206, a buffer unit 207, and a storage unit 208.

The control unit 201 includes a central processing unit (CPU) not shown in the figure, and controls an entire apparatus. Specifically, the control unit 201 is connected to: the video sound output unit 202, the operation input unit 203, the recording unit 204, the first communication unit 205, the second communication unit 206, the buffer unit 207 for temporary storage, and the storage unit 208 in which a program executed in the control unit 201 is stored. For example, the control unit 201 loads a necessary program from the storage unit 208 to the buffer unit 207, executes the loaded program, and controls each of the constituent elements from 202 to 206 in accordance with the execution result.

The video sound output unit 202 and the operation input unit 203 include, for example, an operation screen such as a touch panel, and display a menu to prompt a user to perform an operation and accept an input of the operation from the user. When the user performs an operation, the performed operation is notified to the control unit 201 through the operation input unit 203, and predetermined processing according to the operation is performed.

Note that the video sound output unit 202 and the operation input unit 203 need not necessarily be a touch panel, but may include, for example, a liquid-crystal display and a push button and so on.

The first communication unit 205 is a communication interface through which communication with an external device is performed. According to the present embodiment, the first communication unit 205 wirelessly communicates, via the wireless access point 5, with DTV3, DVR4, or DTV8 which are external devices connected to the network. Specifically, the first communication unit 205 communicates with these external devices by, for example, local area network (LAN). That is, the first communication unit 205 is capable of communicating with one of DTV3, DVR4, and DTV 8 even when the controller 2 and the one of DTV3, DVR4, and DTV8 are not visible to each other. Here, being visible is a state in which there is nothing that blocks the view between the devices.

The second communication unit 206 is a communication interface through which communication with an external device is performed. Here, a communication distance allowing the second communication unit 206 to communicate with the external device is shorter than a communication distance allowing the first communication unit 205 to communicate with the external device.

In the present embodiment, the second communication unit 206 communicates with the external devices (DTV3, DVR4, and DTV8) using an infrared ray. That is, the second communication unit 206 includes a transmission device using an infrared signal, and converts a request that is a response to the user operation into an infrared signal and transmits the converted request to the external devices (DTV3, DVR4, and DTV8), in accordance with an instruction from the control unit 201. Thus, the second communication unit 206 is capable of communicating with external devices, using an infrared communication function which is often included in a mobile terminal such as a cellular phone or a remote controller.

That is, according to the present embodiment, the second communication unit 206 can communicate with the external devices only when the controller 2 and the external devices are visible to each other, and it is possible to perform a unidirectional communication from the controller 2 to the external devices. Accordingly, the second communication unit 206 cannot communicate with an external device located at a position not visually recognizable by the user operating the controller 2. For example, when the controller 2 is in room A, the first communication unit 205 can communicate with DTV8 provided in room B, but the second communication unit 206 cannot communicate with DTV8.

Note that the second communication unit 206 need not necessarily communicate with the external devices using an infrared ray, and may use any technique that allows a shorter communication distance of the second communication unit 206 than that of the first communication unit 205. For example, the second communication unit 206 may communicate with the external devices, using sound waves or ultrashort waves.

The buffer unit 207 is a random access memory (RAM) or the like which provides a working area for the control unit 201.

The storage unit 208 is a flash memory, a hard disk, or the like in which the program executed in the control unit 201 is stored.

FIG. 3 is a block diagram showing a configuration of DTV3 and DTV8 according to the first embodiment of the present invention.

Each of DTV3 and DTV8 includes: a control unit 301, a video sound output unit 302, a broadcast receiving unit 303, an operation input unit 304, a first communication unit 305, a second communication unit 306, a buffer unit 307, and a storage unit 308.

Note that DTV8 has the same configuration as DTV3, and thus the following will describe each constituent element with reference to DTV3 as an example.

The control unit 301 includes a CPU not shown in the figure, and controls the entire apparatus. Specifically, the control unit 301 is connected to: the video sound output unit 302, the broadcast receiving unit 303, the operation input unit 304, the first communication unit 305, the second communication unit 306, the buffer unit 307 for temporary storage, and the storage unit 308 in which a program executed in the control unit 301 is stored. For example, the control unit 301 loads a necessary program from the storage unit 308 to the buffer unit 307, executes the loaded program, and controls each of the constituent elements from 302 to 306 in accordance with the execution result.

The video sound output unit 302 reproduces content, and outputs at least one of a video signal and a sound signal. Specifically, the video sound output unit 302, for example, outputs a video signal to a screen (not shown in the figure), and outputs a sound signal to a speaker (not shown in the figure).

The broadcast receiving unit 303 includes an antenna, a tuner, and a signal processing unit, and receives a video and sound signal. The video and sound signal received by the broadcast receiving unit 303 is temporarily held by the buffer unit 307, and is subsequently displayed on the screen (not shown in the figure) via the video sound output unit 302. Note that DTV3 need not necessarily include the broadcast receiving unit 303.

The first communication unit 305 is a communication interface through which communication with an external device is performed. In the present embodiment, the first communication unit 305 communicates, via the cable 9 and the wireless bridge 6, with the controller 2 and DVR4 that are connected to the network. Specifically, the first communication unit 305 communicates with the external devices by, for example, wired LAN and wireless LAN. That is, the first communication unit 305 can communicate with the controller 2 even when the controller 2 and the one of DTV3 and DTV8 are not visible to each other.

Specifically, for example, in the case of reproducing, in DTV3, the content provided by DVR4, the first communication unit 305 transmits a content-obtainment request command to DVR4. Then, the first communication unit 305 receives the content from DVR4 as a response to the content-obtainment request command. The received content is temporarily stored in the buffer unit 307. Then, the video sound output unit 302 reads the content from the buffer unit 307, and displays the content on the screen (not shown in the figure).

The second communication unit 306 is a communication interface through which communication with an external device is performed. The communication distance allowing the second communication unit 306 to communicate with the external device is shorter than the communication distance allowing the first communication unit 305 to communicate with the external device.

Specifically, according to the present embodiment, the second communication unit 306 communicates with the controller 2 using infrared rays. That is, the second communication unit 306 includes a receiving device that receives an infrared signal, and receives a request transmitted in form of the infrared signal from the controller 2. Then, the control unit 301, after analyzing the received request, performs processing in accordance with the request.

That is, according to the present embodiment, the second communication unit 306 can communicate with the controller 2 only when the controller 2 and one of DTV3 and DTV8 are visible to each other, and it is possible to perform a unidirectional communication from the controller 2 to the one of DTV3 and DTV8.

Note that the second communication unit 306 communicates with the second communication unit 206 included in the controller 2. Accordingly, the second communication unit 306 communicates with the second communication unit 206 in the controller 2 according to the same communication system. That is, when the second communication unit 206 in the controller 2 communicates using sound waves or ultrashort waves, the second communication unit 306 also uses the sound waves or ultrashort waves.

The buffer unit 307 is a RAM or the like which provides a working area for the control unit 301, and temporarily stores the content received by the first communication unit 305.

The storage unit 308 is a flash memory, a hard disk, or the like in which the program executed in the control unit 301 is stored.

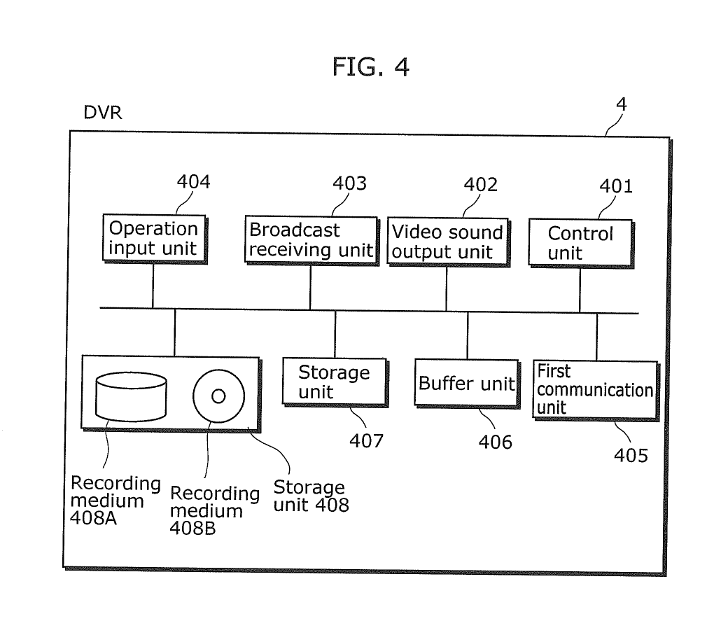

FIG. 4 is a block diagram showing a configuration of DVR4 according to the first embodiment of the present invention.

DVR4 includes: a control unit 401, a video sound output unit 402, a broadcast receiving unit 403, an operation input unit 404, a first communication unit 405, a buffer unit 406, a storage unit 407, and a recording unit 408.

The control unit 401 includes a CPU not shown in the figure, and controls the entire apparatus. Specifically, the control unit 401 is connected to: the video sound output unit 402, the broadcast receiving unit 403, the operation input unit 404, the first communication unit 405, the buffer unit 406 for temporary storage, the storage unit 407 in which a program executed in the control unit 301 is stored, and the recording unit 408 in which the content is recorded. For example, the control unit 401 loads a necessary program from the storage unit 407 to the buffer unit 406, executes the loaded program, and controls each of the constituent elements from 402 to 405 in accordance with the execution result.

The video sound output unit 402 reproduces content, and outputs at least one of a video signal and a sound signal. Specifically, the video sound output unit 402, for example, outputs a video signal to a screen (not shown in the figure), and outputs a sound signal to a speaker (not shown in the figure).

The broadcast receiving unit 403 includes an antenna, a tuner, and a signal processing unit, and receives a video and sound signal. The video and sound signal received by the broadcast receiving unit 403 is temporarily held by the buffer unit 406, and is subsequently displayed on the screen (not shown in the figure) via the video sound output unit 402.

The video and sound signal received by the broadcast receiving unit 403 is temporarily held by the buffer unit 406 as necessary, and is subsequently recorded, as content, on a recording medium 408A or 408B which is attached to the recording unit 408. According to the present embodiment, the recording medium 408A is a hard disk, and the recording medium 408B is a Blu-ray Disc. However, the recording media 408A and 408B need not necessarily be the hard disk or the Blu-Ray Disk.

In the case of reproducing the content recorded on the recording media 408A and 408B, in accordance with an operation performed by the user operating the input unit 404, the content is read from the recording unit 408 to be temporarily stored in the buffer 406, and is subsequently output through the video sound output unit 402.

The first communication unit 405 communicates, via the cable 7, with DTV3 connected to the network. In the case of distributing the content recorded in the recording unit 408 to DTV3 connected via the network, the first communication unit 405 transmits the content to DTV3 as a response to the content-obtainment request command transmitted from DTV3.

The following will describe different types of operation performed in the content reproduction system 1 configured as above.

<Communication Sequence>

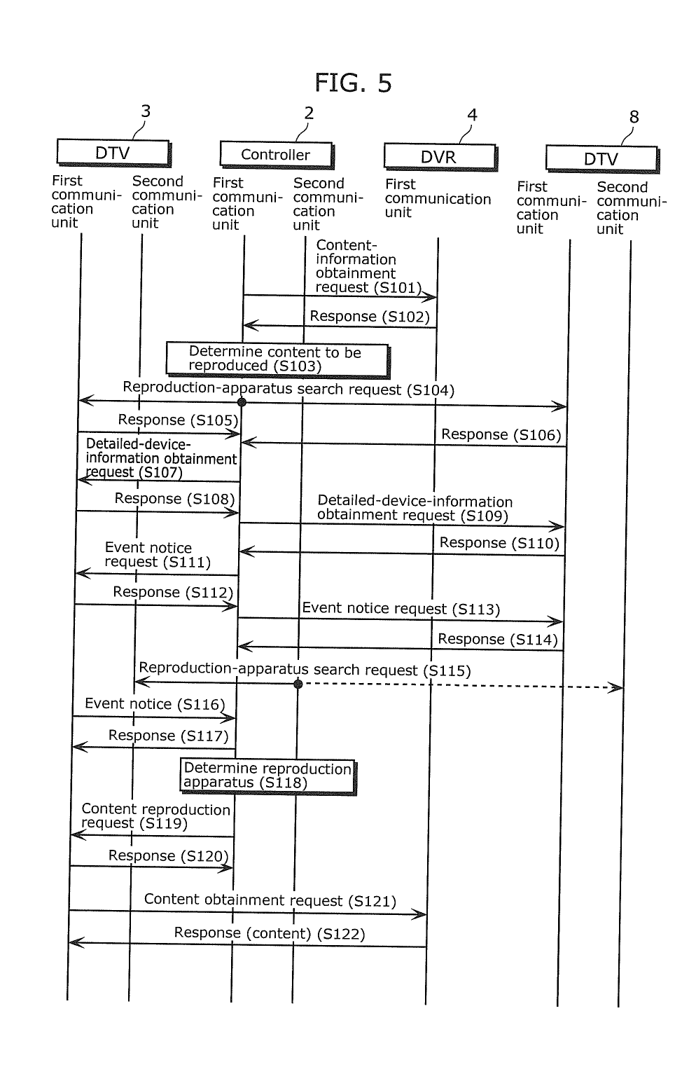

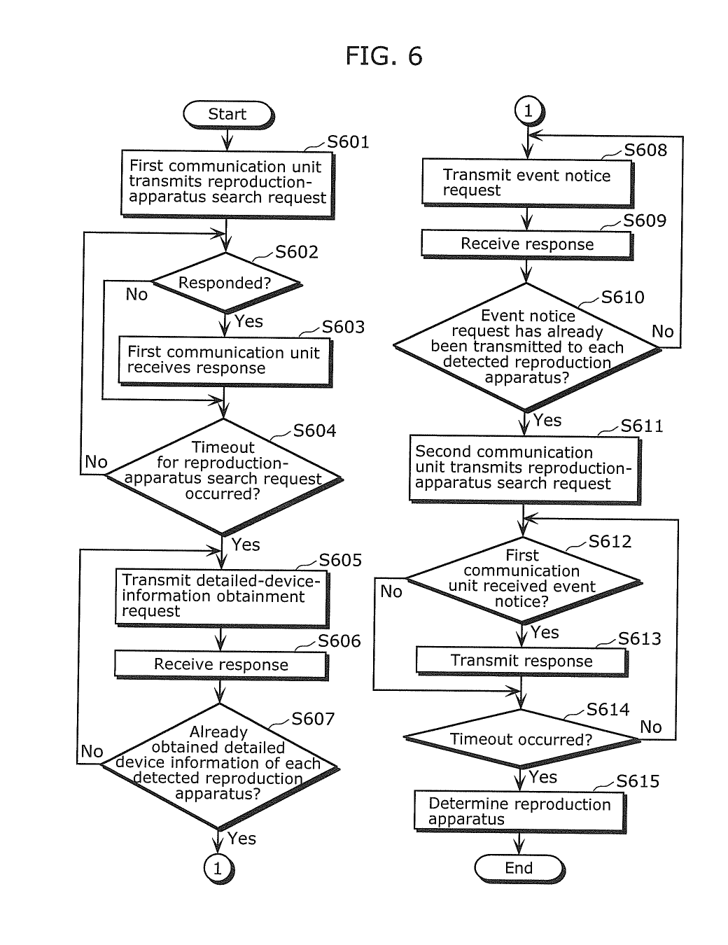

FIG. 5 is a diagram for describing a communication sequence performed in the content reproduction system 1 according to the first embodiment of the present invention.

The user, by operating the controller 2, selects DVR4 connected to the network as a server. After receiving from the user an instruction to select content, the control unit 201 in the controller 2 transmits an obtain-information request command to DVR4 (S101).

The control unit 401 in DVR4 returns, using the first communication unit 405, a response including content information regarding the content that is recorded in the recording unit 408 and can be output to the network (S102). The control unit 201 in the controller 2 displays the content information such as the title of the content at DVR4 on the screen (not shown in the figure) of the controller 2.

The control unit 201 in the controller 2 receives, from the user, the instruction to select the content to be reproduced (S103). After receiving the selection instruction from the user, the control unit 201 in the controller 2 transmits, to the network, a reproduction-apparatus search request command (hereinafter, simply referred to as a “search request command”) for searching for the content reproduction apparatus having a function to reproduce the content (S104). That is, the first communication unit 205 in the controller 2 transmits, to the content reproduction apparatuses (DTV3 and DTV8), a first search request for searching for the apparatus capable of reproducing the content determined in step S103. For example, the first communication unit 205 broadcasts the search request command to the external devices connected to the network.

The control unit 301 in each of DTV3 and DTV 8, having received the search request command from the controller 2, returns to the controller 2, a response to the search request command, using the first communication unit 305 (S105, S106). That is, the control unit 301 transmits a first response to the controller 2, using the first communication unit 305, when the first communication unit 305 receives the first search request. This response includes identification information, information on a detailed-information obtainment source, and so on of DTV3 or DTV8. The identification information includes, for example, an identifier unique to the first communication unit 305, and should preferably include a media access control (MAC) address. With this, it is easier for the controller to uniquely identify DTV3 or DTV8, when the controller 2 communicates using the first communication unit 205.

The control unit 201 in the controller 2 transmits, using the first communication unit 205, a detailed-device-information obtainment request command to each of DTV3 and DTV8 which has returned a response to the search request command (S107, S109).

The control unit 301 in each of DTV3 and DTV8 returns to the controller 2, using the first communication unit 305, a response to the detailed-device-information obtainment request command, which is a response indicating a destination to which an event-notice request is to be transmitted, and so on (S108, S110).

The control unit 201 in the controller 2 transmits to DTV3 and DTV8, using the first communication unit 205, the event-notice request command indicating the destination to which an event notice is to be transmitted, based on the detailed device information obtained from DTV3 or DTV8 (S111, S113). This event-notice request command is a command for requesting to transmit an event notice command to the controller 2, when the second communication unit 306 receives the search request command.

The control unit 301 in each of DTV3 and DTV8, having received the event-notice request command, transmits to the controller 2, using the first communication unit 305, a response indicating that transmitting the event notice command is possible (S112, S114).

Next, the control unit 201 in the controller 2 transmits, using the second communication unit 206, the search request command for searching for the content reproduction apparatus capable of reproducing the content determined in step S103 (S115). That is, the control unit 201 transmits, using the second communication unit 206, the search request command to DTV3 and DTV8 that have returned responses to the event-notice request command. The search request command transmitted here corresponds to a second search request.

According to the present embodiment, the second communication unit 206 in the controller 2 is located in the same room as the second communication unit 306 in DTV3 (room A, within a visible range), and is located in a room different from the room in which the second communication unit 306 in DTV8 is located (room B, out of the visible range). Accordingly, the search request command transmitted in form of an infrared signal reaches DTV3 that is located in the same room A as the controller 2, but does not reach DTV8 that is located in the different room B. That is, the second communication unit 206 in the controller 2 cannot communicate with the second communication unit 306 in DTV8 located in room B that is different from room A where the controller 2 is located.

The control unit 301 in DTV3, after receiving the search request command using the second communication unit 306, transmits to the controller 2, using the first communication unit 305, the event notice command indicating that the search request command has been received (S116). This event notice command corresponds to the response (the second response) to the search request command received in step S115. In addition, the event notice command is also a command for specifying the identification information included in the response transmitted by the first communication unit 305 in step S105.

The control unit 201 in the controller 2, having received the event notice command, transmits, using the first communication unit 205, a response to DTV3 from which the event notice command has been transmitted (S117).

The control unit 201 in the controller 2 determines, as the content reproduction apparatus that is to reproduce the content determined in step S103, the content reproduction apparatus (here, DTV3) indicated by the identification information specified by the event notice command received in step S116 (S118). That is, the control unit 201 determines that DTV3, which has transmitted the event notice command, is the content reproduction apparatus located near the controller 2, and thus determines DTV3 as the content reproduction apparatus that is to reproduce the content determined in step S103.

The control unit 201 in the controller 2 transmits, using the first communication unit 205, a content-reproduction request command indicating a source from which the content is to be obtained (DVR4), to DTV3 that has transmitted the event notice command (S119).

The control unit 301 in DTV3, having received the content-reproduction request command, returns to the controller 2, using the first communication unit 305, a response indicating that reproducing the content is possible (S120).

The control unit 301 in DTV3 transmits, using the first communication unit 305, a content-obtainment request command to DVR4, based on the information indicated by the content-reproduction request command (S121).

The control unit 401 in DVR4, having received the content-obtainment request command, returns a response including the content to DTV3, using the first communication unit 405 (S122). Then, DTV3 reproduces the content transmitted from DVR4 via the network.

With this, DTV3 located near the user operating the controller 2 can reproduce the content from DVR4, which is selected by the user on the controller 2.

<Processing Flow of the Controller>

The following will describe, with reference to FIG. 6, processing for determining the content reproduction apparatus located near the controller 2 from among DTV3 and DTV8 that are a plurality of content reproduction apparatuses connected to the network. FIG. 6 is a flowchart showing a flow of processing performed by the controller 2 according to the first embodiment of the present invention.

When the content to be reproduced is determined from among the contents recorded in DVR4, the control unit 201 transmits to DTV3 and DTV8, using the first communication unit 205, a search request command for searching for the content reproduction apparatus (S601).

Here, when DTV3 or DTV8 returns a response to the search request command (Yes in S602), the first communication unit 205 receives the response including identification information of the content reproduction apparatus (S603). Then, the control unit 201 performs processing for receiving the response. The control unit 201 continues the processing from steps S601 to S603 until a timeout for responding to the search request command occurs (S604).

When the timeout for responding to the search request command occurs (Yes in S604), the control unit 201 transmits, using the first communication unit 205, a detailed-device-information obtainment request command to the content reproduction apparatus from which the response has been received (detected) in S602 (S605). Then, the first communication unit 205 receives a response to the detailed-device-information obtainment request command (S606). The processing in steps S605 and S606 is performed on each content reproduction apparatuses that is detected (S607).

When obtaining the detailed device information of each content reproduction apparatus is completed (Yes in S607), the control unit 201 transmits, using the first communication unit 205, an event-notice request command to the detected content reproduction apparatus (S608). Then, the first communication unit 205 receives a response to the event-notice request command (S609). The processing in steps S608 and S609 is performed on each content reproduction apparatus that is detected (S610).

When the event-notice request command is transmitted to each detected content reproduction apparatus, and when a response thereto is received (Yes in S610), the control unit 201 transmits, using the second communication unit 206, the search request command to the content reproduction apparatus (S611).

Subsequently, when the first communication unit 205 receives an event notice command from the content reproduction apparatus that has received the search request command (Yes in S612), the control unit 201 performs processing for receiving the event notice command and also transmits a response to the content reproduction apparatus that has transmitted the event notice command (S613). The controller 2 continues a waiting state for the event notice until a predetermined event-notice waiting timeout occurs (S614). According to the present embodiment, DTV3 is the content reproduction apparatus that transmits the event notice command.

When the event-notice waiting timeout occurs (Yes in S614), the control unit 201 determines DTV3 which is the content reproduction apparatus that has transmitted the event notice command, as the content reproduction apparatus that is to reproduce the content (S615).

<DTV Processing Flow>

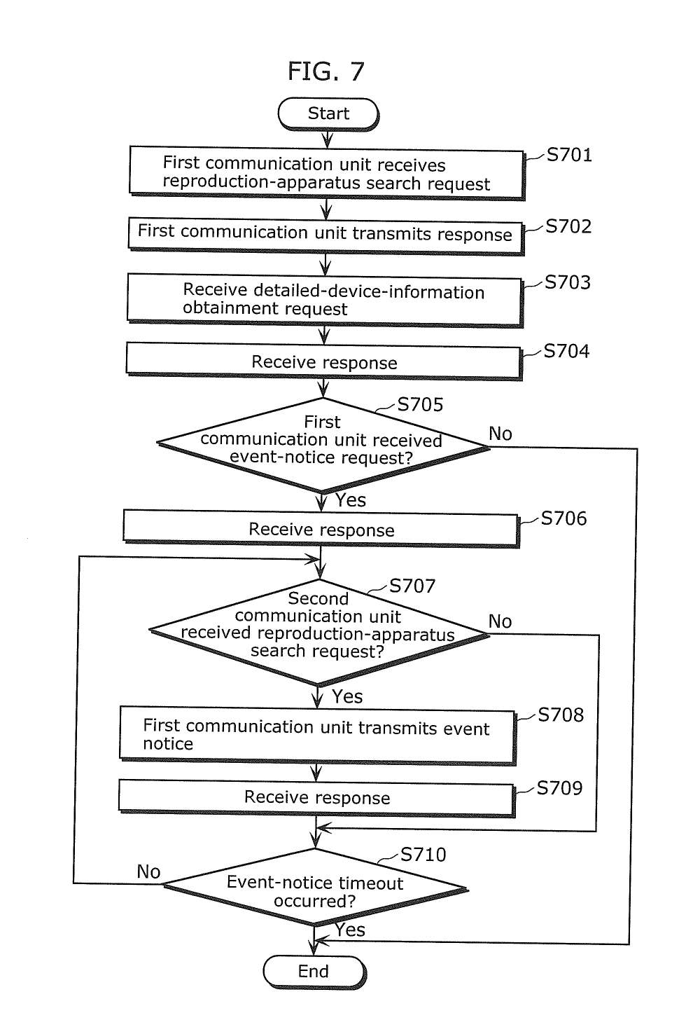

The following will describe, with reference to FIG. 7, processing performed by DTV3 or DTV8 for communicating with the controller 2 connected to the network. FIG. 7 is a flowchart showing a flow of the processing performed by the DTV according to the first embodiment of the present invention.

First, the first communication unit 305 receives a search request command from the controller 2 (S701). Subsequently, the control unit 301 transmits, using the first communication unit 305, a response to the received search request command (S702).

The first communication unit 305 receives a detailed-device-information obtainment request command from the controller 2 (S703). Subsequently, the control unit 301 transmits, using the first communication unit 305, a response to the detailed-device-information obtainment request command that is received (S704).

Here, when the first communication unit 305 receives the event-notice command from the controller 2 (Yes in S705), the control unit 301 transmits, using the first communication unit 305, a response to the event-notice request command (S706).

The second communication unit 306 enters a waiting state for receiving a search request command (S707).

When the second communication unit 206 receives the search request command during the waiting state for receiving the search request command (Yes in S707), the control unit 301 transmits, using the first communication unit 305, an event notice command indicating that the search request command has been received, to the controller 2 which has transmitted the event-notice request command (S708). Subsequently, the first communication unit 305 receives a response to the event notice command from the controller 2 (S709). On the other hand, when the second communication unit 306 does not receive the search request command (No in S707), the processing proceeds to step S710.

The waiting state for receiving the search request command continues for a timeout period indicated by the event-notice request command received by the first communication unit 305 (S710). That is, when the second communication unit 306 receives the search request command during a predetermined time after the first communication unit 305 received the event-notice request command, the control unit 301 transmits an event notice, using the first communication unit 305. Here, the predetermined time is a period of time indicated by the event-notice request command. Note that the predetermined time need not necessarily be within the time indicated by the event-notice request command, but may be, for example, another predetermined period of time.

When the timeout occurs (Yes in S710), DTV3 and DTV8 terminate the waiting state of the second communication unit 306 for receiving the search request command.

Since the series of processing described above allows the controller 2 to automatically select DTV3 that is located nearest from among DTV3 and DTV8, it is not necessary for the user to explicitly select DTV3 located nearby according to the position at which the user is operating the controller 2.

Thus, in the content reproduction system according to the present embodiment, the second communication unit 206 in the controller 2 and the second communication unit 306 in DTV3 and DTV8 can communicate with each other only when they are visible to each other. Furthermore, the first communication unit 205 in the controller 2 transmits the event-notice request command, and subsequently the second communication unit 206 in the controller 2 transmits the search request command.

Then, only when the first communication unit 205 in the controller 2 receives the event notice command as a response to this search request command, the content reproduction apparatus from which the event notice command has been transmitted is determined as the content reproduction apparatus that is to reproduce the content.

This allows the controller 2 to automatically select the content reproduction apparatus based on the location of the controller 2, without requiring the user to explicitly select the content reproduction apparatus.

That is, according to the present embodiment, the content reproduction apparatus can transmit, using the first communication unit 305, a response for specifying the identification information already transmitted by the first communication unit 305 to the controller 2, when the second communication unit 306 allowing a shorter communication distance than the communication distance of the first communication unit 305 receives the search request command. Thus, the controller 2 can specify the identification information of the content reproduction apparatus capable of communicating using the second communication unit 206, that is, the content reproduction apparatus located near the controller 2. As a result, the controller 2 can automatically determine, based on the location of the controller, the content reproduction apparatus that is to reproduce the content provided via the network, without obtaining detailed location information of the controller 2 and the content reproduction apparatus.

In addition, according to the present embodiment, the second communication unit 306 in the content reproduction apparatus can communicate with the second communication unit 206 in the controller 2 only when the second communication unit 306 is visible to the controller 2. Accordingly, the content reproduction apparatus located at a position that is not visually recognizable by the user operating the controller 2 cannot receive the search request command using the second communication unit 306. That is, the controller 2 can specify the identification information of the content reproduction apparatus located at a position visually recognizable by the user operating the controller 2. Therefore, the controller 2 can automatically determine, based on the location of the controller 2, the content reproduction apparatus that is located at a position visually recognizable by the user operating the controller 2.

### Second Embodiment

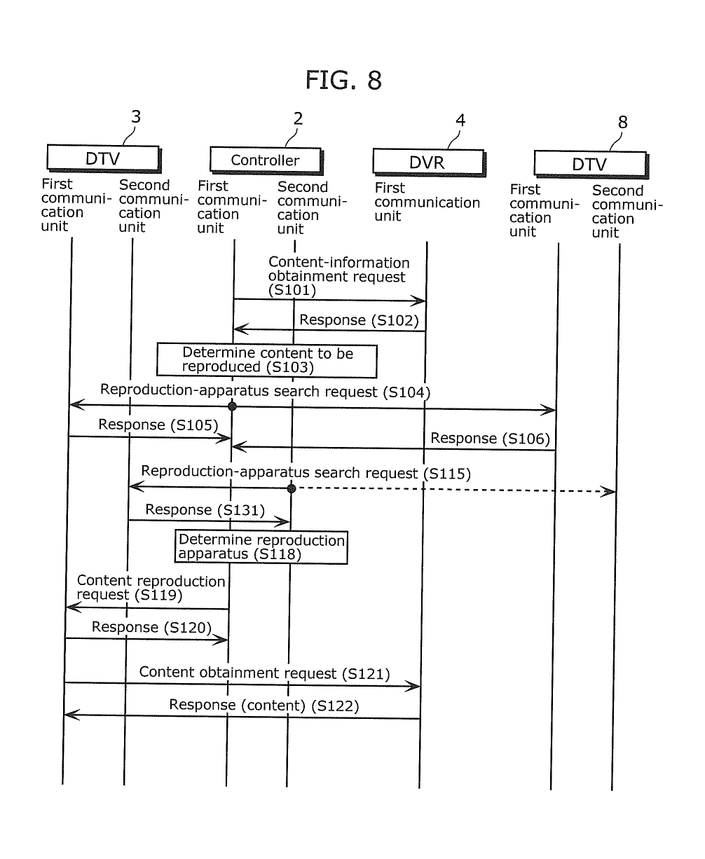

Next, a second embodiment of the present invention will be described with reference to FIGS. 8 to 10.

The present embodiment is different from the first embodiment in that the second communication units 206 and 306 can bidirectionally communicate with each other through wireless connection. The following will mainly describe the difference from the first embodiment.

Since the configuration of the content reproduction system 1 is the same as that in FIG. 1, the illustration and description thereof will be omitted. In addition, since the configurations of the controller 2, DTV3 and DTV8, and DVR4 are the same as those in FIGS. 2 to 4, the descriptions thereof will be omitted.

The second communication unit 206 in the controller 2 can wirelessly and bidirectionally communicate with the second communication unit 306 in DTV3 and DTV8. However, a communication distance allowing a communication between the second communication units 206 and 306 is shorter than a communication distance allowing a communication between the first communication units 205 and 305. Specifically, the second communication unit 206 in the controller 2 communicates with the second communication unit 306 in one of DTV3 and DTV8 by, for example, Bluetooth.

According to the present embodiment, when the controller 2 is located in room A, the second communication unit 206 in the controller 2 can communicate with the second communication unit 306 in DTV3, but cannot communicate with the second communication unit 306 in DTV8. Note that, as with the first embodiment, when the controller 2 is located in room A, the first communication unit 205 in the controller 2 can communicate with the first communication unit 305 in DTV3 and DTV8.

<Communication Sequence>

FIG. 8 is a diagram for describing a communication sequence in the content reproduction system 1 according to the second embodiment of the present invention. Note that in FIG. 8, the same processing as in FIG. 4 is assigned with the same numerical reference, and the description thereof will be omitted accordingly.

As in the first embodiment, after performance of the processing in steps S101 to 106, the control unit 201 in the controller 2 transmits a search request command, using the second communication unit 206 (S115). Then, the control unit 301 in DTV3 transmits to the controller 2, using the second communication unit 306, a response to the search request command (S131). This response corresponds to the second response, and is a response for specifying the identification information of DTV3 included in the response in step S105. The identification information includes an identifier (for example, MAC address) unique to the first communication unit 305 in DTV3.

Subsequently, the processing in steps S118 to S122 is performed as in the first embodiment.

<Processing Flow of the Controller>

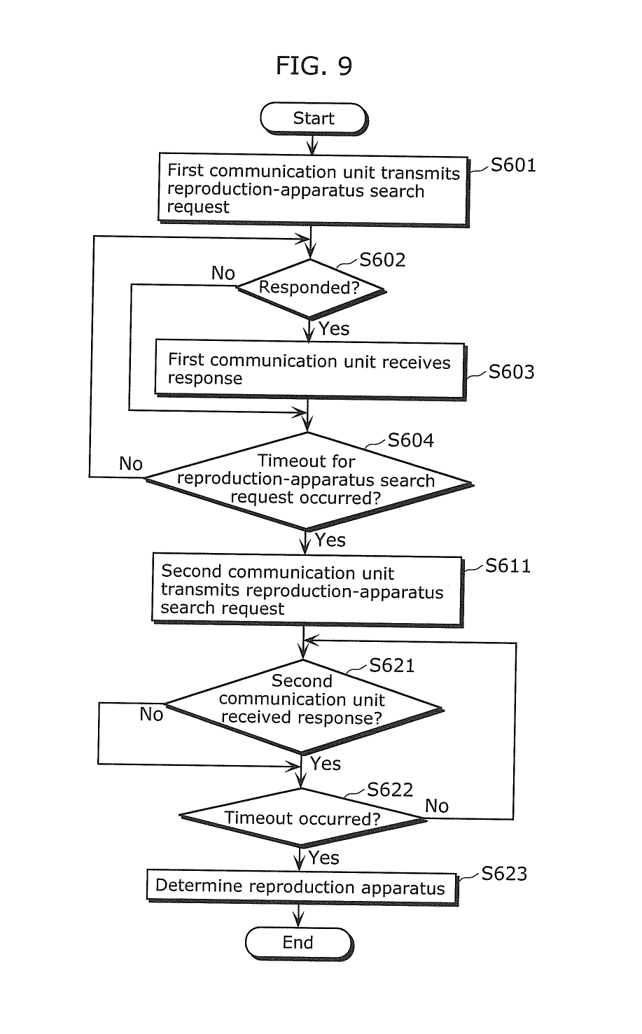

FIG. 9 is a flowchart showing a flow of processing performed by the controller 2 according to the second embodiment of the present invention. Note that in FIG. 9, the same processing as in FIG. 6 is assigned with the same numerical reference, and the description thereof will be omitted accordingly.

When a timeout for responding to the search request command occurs (Yes in S604), the control unit 201 transmits to the content reproduction apparatus, using the second communication unit 206, a search request command for searching for the apparatus capable of reproducing the content (S611).

Subsequently, the second communication unit 206 receives, from the content reproduction apparatus which has received the search request command, a response to the search request command, which is a response for specifying the identification information included in the response received in step S603 (S621). Note that the waiting state for receiving the response continues until the timeout occurs (S622).

When the timeout occurs (Yes in S622), the control unit 201 determines the content reproduction apparatus that has transmitted the response (here DTV3), as the content reproduction apparatus that is to reproduce the content (S623).

<DTV Processing Flow>

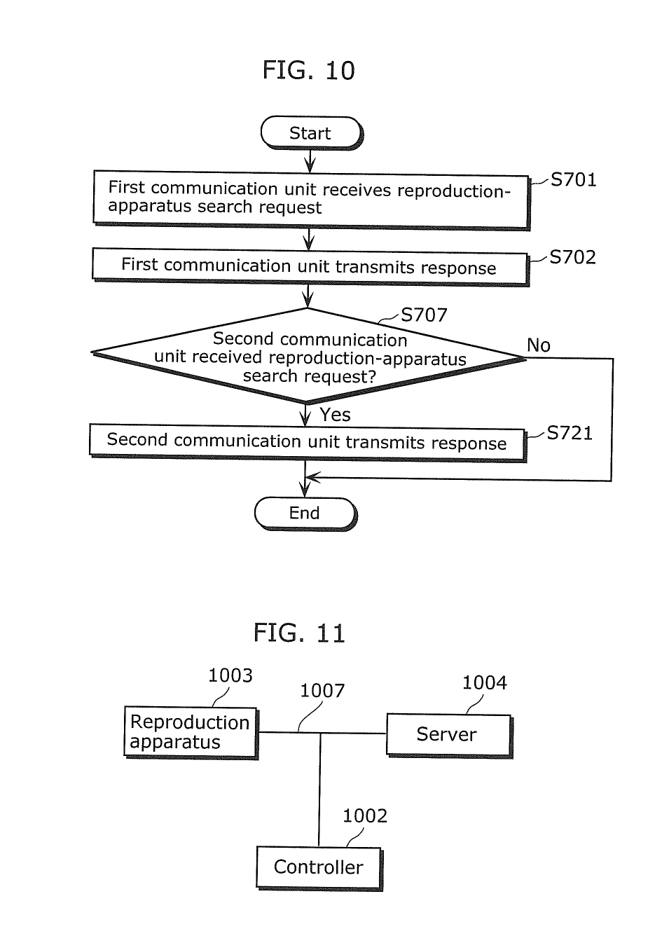

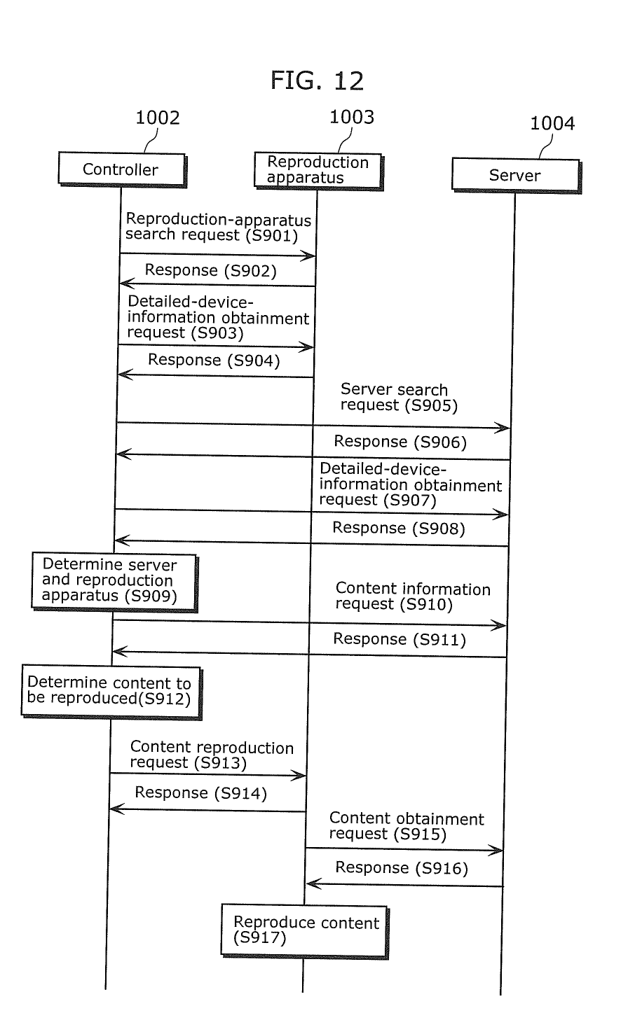

FIG. 10 is a flowchart showing a flow of processing performed by the DTV according to the second embodiment of the present invention. Note that in FIG. 10, the same processing as in FIG. 7 is assigned with the same numerical reference, and the description thereof will be omitted accordingly.

After performance of processing in steps S701 and S702, the second communication unit 306 receives the search request command for searching for the apparatus capable of reproducing the content (S721). Subsequently, the control unit 301 transmits to the controller 2, using the second communication unit 306, a response to the search request command received in step S721, which is a response for specifying the identification information included in the response transmitted in step S702 (S722).

As described above, according to the present embodiment, the content reproduction apparatus can transmit, using the second communication unit 306, a response for specifying the identification information already transmitted by the first communication unit 305 to the controller 2, when the second communication unit 306 allowing a shorter communication distance than the communication distance of the first communication unit 305 receives the search request command. Thus, the controller 2 can specify the identification information of the content reproduction apparatus capable of communicating using the second communication unit 206, that is, the content reproduction apparatus located near the controller 2. As a result, the controller 2 can automatically determine, based on the location of the controller 2, the content reproduction apparatus that is to reproduce the content provided via the network, without obtaining detailed location information of the controller 2 and the content reproduction apparatus.

Thus far, the content reproduction system 1 according to an implementation of the present invention has been described based on some embodiments, but the present invention is not limited to these embodiments. Those skilled in the art will readily appreciate that many modifications are possible in the exemplary embodiments without materially departing from the novel teachings and advantages of this invention. Accordingly, all such modifications are intended to be included within the scope of this invention.

For example, in the first or second embodiment described above, the processing for determining the content reproduction apparatus is performed after the user determines the content to be reproduced; however, the processing is not limited to this order. For example, the processing for determining the content reproduction apparatus may be performed immediately after determining the content output apparatus.

In addition, the first or second embodiment above has described the processing for determining DTV3 as the content reproduction apparatus that is to reproduce the content, when the controller 2 is located near DTV3. When the controller 2 is located near DTV8, it is possible to determine, in the same manner as described above, DTV8 as the content reproduction apparatus that is to reproduce the content.

In addition, in the first or second embodiment described above, the first communication unit 205 in the controller 2 and the first communication unit 305 in DTV3 and DTV8 are wiredly or wirelessly connected to each other; however, the configuration may allow either wired or wireless connection.

In addition, the first or second embodiment above has described the content reproduction apparatus as a DTV; however, the content reproduction apparatus may be an audio reproduction apparatus such as an audio system or a theater system in the case where the content to be reproduced is acoustic data.

In addition, in the first or second embodiment above, the control unit 201 in the controller 2 transmits, using the first communication unit 205, the first search request to the content reproduction apparatuses (DTV3 and DTV8); however, the control unit 201 need not necessarily transmit the first search request to the content reproduction apparatuses. For example, the control unit 201 in the controller 2 may transmit the first search request to a search device (for example, a content output device) which is a device to search for the content reproduction apparatus connected to the network. In this case, the search apparatus, having received the first search request from the controller 2, transmits, to the content reproduction apparatuses (DTV3 and DTV8), a search request command for searching for the content reproduction apparatus connected to the network. In addition, for example, the search apparatus may previously transmit the search request command to the content reproduction apparatuses before receiving the first search request from the controller 2, and may transmit, as a response to the first search request, list information indicating the content reproduction apparatus connected to the network.

In addition, the present invention can be realized not only as a controller or content reproduction apparatus including such a characteristic processing unit but also as a method including, as steps, such a characteristic processing unit included in the controller or the content reproduction apparatus. In addition, the present invention may be realized as a computer program causing a computer to execute each of the characteristic steps included in such a method. Furthermore, it goes without saying that it is possible to distribute such a computer program via a non-transitory computer-readable recording medium such as a CD-ROM or a communication network such as the Internet.

### INDUSTRIAL APPLICABILITY

The present invention is applicable to a content reproduction system which causes, via a controller, a content reproduction apparatus such as a digital television (DTV) having a function to display content, which is called a renderer, to display content stored in a content output apparatus such as a digital video recorder (DVR) located in house, a portable controller included in the content reproduction system, and the content reproduction apparatus such as the DTV.

What is claimed is:

1. A content reproduction apparatus capable of reproducing, in accordance with an instruction from a controller, content provided from a content output apparatus via a network, said content reproduction apparatus comprising:
a first communication unit configured to receive a first search request to search for an apparatus capable of reproducing the content;
a second communication unit configured to receive a second search request from the controller, said second communication unit having a shorter communication distance that allows communication with the controller than a communication distance of said first communication unit, and the second search request being a request to search for the apparatus capable of reproducing the content; and
a control unit configured to transmit to the controller, using said first communication unit, a first response including identification information of said content reproduction apparatus when said first communication unit receives the first search request, and to transmit to the controller, using one of said first and second communication units, a second response to specify the identification information included in the first response that has been transmitted, when said second communication unit receives the second search request.

2. The content reproduction apparatus according to claim 1,
wherein said first communication unit is further configured to receive, from the controller, an event notice request which requests a transmission of an event notice to the controller when said second communication unit receives the second search request, and
said control unit is configured to transmit, using said first communication unit, the event notice as the second response, when said second communication unit receives the second search request during a predetermined period of time after said first communication unit receives the event notice request.

3. The content reproduction apparatus according to claim 1,
wherein said first communication unit is configured to communicate with the controller even when the controller and said content reproduction apparatus are not visible to each other, and
said second communication unit is configured to communicate with the controller only when the controller and said content reproduction apparatus are visible to each other.

4. The content reproduction apparatus according to claim 1,
wherein said second communication unit is configured to unidirectionally communicate from the controller to said content reproduction apparatus, and
said control unit is configured to transmit the second response to the controller, using said first communication unit.

5. The content reproduction apparatus according to claim 4,
wherein said second communication unit is configured to communicate with the controller, using an infrared ray.

6. The content reproduction apparatus according to claim 1,
wherein said second communication unit is configured to bidirectionally and wirelessly communicate with the controller, and
said control unit is configured to transmit the second response to the controller, using said second communication unit.

7. The content reproduction apparatus according to claim 6,
wherein said second communication unit is configured to communicate with the controller by Bluetooth.

8. The content reproduction apparatus according to claim 1,
wherein the identification information included in the first response includes an identifier unique to said first communication unit.

9. A communication method performed by a content reproduction apparatus capable of reproducing, in accordance with an instruction from a controller, content provided from a content output apparatus via a network, said communication method comprising:
receiving, using a first communication unit, a first search request to search for an apparatus capable of reproducing the content;
transmitting, using the first communication unit, a first response after receiving the first search request, the first response including identification information of the content reproduction apparatus;
receiving, using a second communication unit, a second search request from the controller, the second communication unit having a shorter communication distance that allows communication with the controller than a communication distance of the first communication unit, and the second request being a request to search for the apparatus capable of reproducing the content; and
transmitting, after receiving the second search request, a second response to the controller, using one of the first and second communication units, the second response being for specifying identification information included in the first response transmitted in said transmitting of a first response.

10. A non-transitory computer-readable recording medium on which a program is recorded, the program causing a computer to execute the communication method according to claim 9.

11. A controller which determines a content reproduction apparatus that is to reproduce content provided from a content output apparatus via a network, said controller comprising:
a first communication unit configured to transmit a first search request to search for an apparatus capable of reproducing the content, and to receive a first response to the first search request;
a second communication unit configured to transmit a second search request to a content reproduction apparatus that is identified by the first response, said second communication unit having a shorter communication distance that allows communication with the content reproduction apparatus than a communication distance of said first communication unit, and the second search request being a request to search for the apparatus capable of reproducing the content; and
a control unit configured to determine, as the content reproduction apparatus that is to reproduce the content, the content reproduction apparatus that has transmitted a second response to the second search request, when one of said first and second communication units receives the second response.

12. A reproduction apparatus determination method performed by a controller which determines a reproduction apparatus that is to reproduce content provided from a content output apparatus via a network, said reproduction apparatus determination method comprising:
transmitting, using a first communication unit, a first search request to search for an apparatus capable of reproducing the content;
receiving a first response to the first search request, using the first communication unit;
transmitting, using a second communication unit, a second search request to the content reproduction apparatus identified by the first response, the second communication unit having a shorter communication distance that allows communication with the content reproduction apparatus than a communication distance of the first communication unit, and the second search request being a request to search for the apparatus capable of reproducing the content; and
determining, as the content reproduction apparatus that is to reproduce the content, the content reproduction apparatus that has transmitted a second response to the second search request, when the second response is received using one of the first and second communication units.

13. A non-transitory computer-readable recording medium on which a program is recorded, the program causing a computer to execute the reproduction apparatus determination method according to claim 12.

14. A content reproduction system, comprising:
a content output apparatus;
a controller; and
a content reproduction apparatus capable of reproducing, in accordance with an instruction from said controller, content provided from said content output apparatus via a network,
wherein said controller includes:
a first communication unit configured to transmit a first search request to search for an apparatus capable of reproducing the content, and to receive a first response to the first search request;
a second communication unit configured to transmit a second search request to the content reproduction apparatus identified by the first response, said second communication unit having a shorter communication distance that allows communication with said content reproduction apparatus than a communication distance of said first communication unit, and the second search request being a request to search for the apparatus capable of reproducing the content; and
a first control unit configured to determine, as the content reproduction apparatus that is to reproduce the content, the content reproduction apparatus that has transmitted a second response to the second search request, when one of said first and second communication units receives the second response, and
said content reproduction apparatus includes:
a third communication unit configured to receive the first search request;
a fourth communication unit configured to receive the second search request from said controller, said fourth communication unit having a shorter communication distance that allows communication with said controller than a communication distance of said third communication unit; and
a second control unit configured to transmit, using said third communication unit, the first response to said controller when said third communication unit receives the first search request, and to transmit, using one of said third and fourth communication units, the second response to said controller when said fourth communication unit receives the second search request.
